(19) United States
(12) Patent Application Publication
(10) Pub. No.: US 2025/0217900 A1
(43) Pub. Date: Jul. 3, 2025

(54) SYSTEMS AND METHODS FOR CONDUCTING CHALLENGES ON SOCIAL MEDIA PLATFORMS

(71) Applicant: INMO, LLC, Birmingham, AL (US)

(72) Inventor: Blake Patterson, Birmingham, AL (US)

(73) Assignee: INMO, LLC, Birmingham, AL (US)

(21) Appl. No.: 18/999,949

(22) Filed: Dec. 23, 2024

Related U.S. Application Data
(60) Provisional application No. 63/616,222, filed on Dec. 29, 2023.

(51) Int. Cl. G06Q 50/00; G06Q 20/36; G07C 13/00

(52) U.S. Cl. CPC G06Q 50/01; G06Q 20/36; G07C 13/00

(57) ABSTRACT

Systems and methods are disclosed herein for incentivizing creative or original content on a digital platform via challenge functionality in a social media platform. The systems and methods can allow for a challenge creator to create a challenge, post creators to create posts for the challenge, which can be displayed to voters for voting on the posts. The systems and methods can rank the votes based on criteria, and payments can be transferred to the challenge creator, post creators, and/or voters based on the ranking as a reward for a high ranking post.

### CROSS-REFERENCE TO RELATED APPLICATIONS

This application claims priority to and the benefit of U.S. Provisional Patent Application No. 63/616,222, entitled “Systems and Methods for Conducting Challenges on Social Media Platforms,” filed Dec. 29, 2023, which is hereby incorporated by reference in its entirety.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present disclosure is directed to a system for operating a digital platform with challenge functionality.

### BACKGROUND

The present disclosure generally relates to a digital platform with challenge functionality, and more particularly to systems and methods for incentivizing creative or original content on a digital platform. Current social media platforms do not reward original content and can cause content creators to regurgitate content rather than create something original, especially when original content does not earn the growth and engagement that the content creators are hoping for. What is needed is a platform that is configured to heighten the reward for content creators posting original content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to systems and methods for incentivizing creative or original content on a digital platform via challenge functionality. Current social media platforms do not reward original content and can cause content creators to regurgitate content rather than create something original, especially when original content does not earn the growth and engagement that the content creators are hoping for. What is needed is a platform that is configured to heighten the reward for content creators posting original content. In particular, originality can be encouraged by rewarding a content creator, such as with a payment, in response to votes on the creator's post. Content creators can be rewarded in a manner proportional to votes made on posts created by the content creators in response to a challenge. The posts can be created by post creators in response to a challenge and voters can vote on the posts. The posts can be ranked and the post creators with the highest ranked posts can be rewarded with a payment. A digital platform can operate to allow for the exchange of information between users of the platform, such as a social media platform with users comprising challenge creators, post creators, voters, or a combination thereof.

One aspect of the disclosure is a system having at least one processor and at least one memory with non-transitory computer-executable instructions stored thereon. The non-transitory computer-executable instructions may be configured to perform one or more operations when executed by the at least one processor. The one or more operations may include providing a web-based portal accessible via a computer application on a user device. The one or more operations may include receiving a challenge request from a challenge creator. The one or more operations may include generating a challenge in response to the challenge request. The one or more operations may include receiving post requests from a plurality of post creators in response to the challenge. The one or more operations may include generating posts in response to the post requests, each post associated with one of the plurality of post creators. The one or more operations may include displaying, on a graphical user interface of the user device, the posts via the web-based portal. The one or more operations may include receiving vote requests from a plurality of voters, each vote request including at least one of the posts. The one or more operations may include generating votes in response to the vote requests, each vote including at least one of the posts and associated with one of the plurality of voters. The one or more operations may include ranking the posts based on the votes for each of the posts. The one or more operations may include receiving a payment request. The one or more operations may include initiating, based on the ranking of the posts, payment to one or more of the challenge creator, at least one of the plurality of post creators, or at least one of the plurality of voters in response to the payment request.

Another aspect of the disclosure is a system having at least one processor and at least one memory with non-transitory computer-executable instructions stored thereon. The non-transitory computer-executable instructions may be configured to perform one or more operations when executed by the at least one processor. The one or more operations may include accessing a web-based portal via a computer application on a second computing device, wherein posts are displayed on a graphical user interface of the second computing device via the web-based portal, each post associated with a post creator from among a plurality of post creators in response to a challenge. The one or more operations may include sending, to the first computing device, at least one vote request including at least one of the posts, the at least one of the posts selected via a user interface element of the graphical user interface, wherein the at least one vote request is sent in response to the user interface element selection. The one or more operations may include sending, to the first computing device, a payment request. The one or more operations may include receiving, based on a ranking of the posts based on votes for each of the posts, a payment in response to the payment request, wherein the votes include a vote generated from the vote request.

Another aspect of the disclosure is a method. The method may include a method for incentivizing creative or original content on a digital platform via challenge functionality. The method may include providing, by a computing device, a web-based portal accessible via a computer application on a user device. The method may include receiving, by the computing device, a challenge request from a challenge creator. The method may include generating, by the computing device, a challenge in response to the challenge request. The method may include receiving, by the computing device, post requests from a plurality of post creators in response to the challenge. The method may include generating, by the computing device, posts in response to the post requests, each post associated with one of the plurality of post creators. The method may include displaying, by the computing device on a graphical user interface of the user device, the posts via the web-based portal. The method may include receiving, by the computing device, vote requests from a plurality of voters, each vote request including at least one of the posts. The method may include generating, by the computing device, votes in response to the vote requests, each vote including at least one of the posts and associated with one of the plurality of voters. The method may include ranking, by the computing device, the posts based on the votes for each of the posts. The method may include receiving, by the computing device, a payment request. The method may include initiating, by the computing device based on the ranking of the posts, payment to one or more of the challenge creator, at least one of the plurality of post creators, or at least one of the plurality of voters in response to the payment request.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure. In the drawings:

FIG. 1 is a schematic block diagram depicting one embodiment of a system of the present disclosure.

FIG. 2 is a schematic block diagram depicting one embodiment of the system of the present disclosure.

FIG. 3 is a schematic block diagram depicting one embodiment of the system of the present disclosure.

FIG. 4 is a schematic block diagram depicting one embodiment of a memory of the system of the present disclosure.

FIG. 5 is a visualization of one embodiment of a blockchain of the present disclosure.

FIG. 6 is a visualization of one embodiment of non-transitory computer-executable instructions of the present disclosure.

FIG. 7 is a schematic block view depicting one embodiment of a system of the present disclosure.

FIG. 8 is a flowchart diagram depicting one embodiment of a method of the present disclosure.

### DETAILED DESCRIPTION

Reference will now be made in detail to exemplary embodiments of the disclosure, some aspects of which are illustrated in the accompanying drawings.

In various embodiments, the present disclosure relates to a digital platform with challenge functionality. This disclosure further relates to systems that transfer digital assets, such as cryptocurrency or non-fungible tokens (NFTs), between one or more parties through challenge functionality. Moreover, this disclosure relates to methods and systems for incentivizing creative or original content on a challenge platform via challenge functionality. In particular, the systems and methods of the present disclosure may incentivize creative or original content by rewarding content creators with digital assets for creating and sharing original or well-received content. In particular, this disclosure further relates to systems that allow challenge creators to generate challenges that post creators can generate posts in response to and that allow voters to vote on the best posts. The post creator of the highest ranked post or the post creators of the top several posts may receive a reward or a share of a reward. The systems and methods can reward challenge creators, post creator(s) of the highest ranked post(s), and voters that vote for post(s) that are the highest ranked with a reward or share of a reward. In this way, the systems and methods of the present disclosure incentivize (1) challenge creators to create more engaging challenges, (2) post creators to create more original, creative, and engaging content, and (3) users to engage with their favorite content.

At a high level, a challenge is an invitation to post creators (i.e., content creators) to make a post that meets a particular set of criteria. Voters may then vote on the posts of a given challenge to determine the winner(s) of the challenge. The winners of the challenge may then receive a payment as a reward for winning the challenge. The systems and methods of the present disclosure are discussed in more detail below.

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and any accompanying claims.

The described systems and techniques can be performed by a system that includes a single computer or more than one computer. A computer can be a processor-controlled device, such as, by way of example, personal computers, workstations, servers, clients, mini-computers, mainframe computers, laptop computers, smartphones, tablets, a network of one or more individual computers, mobile computers, portable computers, handheld computers, palmtop computers, set-top boxes for a TV, interactive televisions, interactive kiosks, personal digital assistants, interactive wireless devices, or any combination thereof.

A computer can be a uniprocessor or multiprocessor machine. Accordingly, a computer may include one or more processors and, thus, the aforementioned system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), gated logic, and other suitable hardware configured to perform the various functionality described throughout this disclosure.

Additionally, the computer may include one or more memories. Accordingly, the aforementioned system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data.

In particular, the one or more memories may store computer-executable instructions that, when executed by the one or more processors, cause the one or more processors to implement the procedures and techniques described herein. The one or more processors can be operably associated with the one or more memories so that the computer-executable instructions can be provided to the one or more processors for execution. For example, the one or more processors can be operably associated to the one or more memories through one or more buses. Furthermore, the computer may possess or can be operably associated with input devices (e.g., a keyboard, a keypad, controller, a mouse, a microphone, a touch screen, a sensor) and output devices such as (e.g., a computer screen, printer, or a speaker).

The computer may execute an appropriate operating system such as LINUX®, UNIX®, MICROSOFT® WINDOWS®, APPLE® MACOS®, IBM® OS/2®, ANDROID, and PALM® OS, and/or the like. The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator can be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices can be used with programs constructed in accordance with some of the teachings described herein. In some embodiments, very specific computing machines, with specific functionality, can be required. Similarly, it may prove advantageous to construct a specialized apparatus to perform the method steps described herein by way of dedicated systems with hard-wired logic or programs stored in nonvolatile memory, such as, by way of example, read-only memory (ROM).

In some embodiments, features of the systems can be implemented primarily in hardware using, for example, hardware components such as application-specific integrated circuits (ASICs) or field-programmable gate arrays (FPGAs). Implementation of the hardware circuitry will be apparent to persons skilled in the relevant art(s). In yet another embodiment, features of the systems can be implemented using a combination of both general-purpose hardware and software.

In some embodiments, the systems and methods herein are used to transfer digital assets. A digital asset is any information that can be stored, transmitted, interpreted, and used that is encoded in a numeric format, including but not limited to information encoded as binary data. Generally, digital assets are stored in binary format, but other non-binary forms of encoding and storage can be known or developed for creating digital assets. Examples of digital assets include but are not limited to digital documents, audio, video, text, executable code in various formats, and any other type of information. Digital assets are not limited by the means of storage or transport, which can be electronic, optical, or other types of storage or transport mechanisms existing or to be developed in the future.

In embodiments, the systems and methods comprise a digital platform for exchanging information between users of the platform. For instance, the digital platform can comprise a social media platform and the users of the platform can comprise content creators (such as challenge creators and post creators), content consumers, or a combination thereof.

A blockchain, as used herein, can refer to a peer-to-peer, electronic ledger that is implemented as a computer-based decentralized, distributed computer-implemented system made up of blocks which, in turn, are made up of transactions. Each transaction is a data structure that encodes the transfer of control of a digital asset between participants in the blockchain computer-implemented system and includes at least one input and at least one output. Each block contains a hash of the previous block so that blocks become chained together to create a permanent, unalterable record of all transactions that have been recorded to the blockchain since its inception. Transactions contain small programs, known as scripts, embedded into their inputs and outputs, which specify how and by whom the outputs of the transactions can be accessed.

For a transaction to be recorded on the blockchain, it must be “validated.” Network nodes (miners) perform work to ensure that each transaction is valid, with invalid transactions rejected from the network. Software clients installed on the nodes perform this validation work on an unspent transaction by executing its locking and unlocking scripts. If execution of the locking and unlocking scripts evaluates to TRUE, the transaction is valid and the transaction is recorded to the blockchain. Thus, for a transaction to be recorded to the blockchain, it should be i) validated by the first node that receives the transaction-if the transaction is validated, the node relays it to the other nodes in the network; and ii) added to a new block built by a miner; and iii) mined, i.e., added to the public ledger of past transactions.

Blockchain can be used for the implementation of “smart contracts.” These are computer programs designed to automate the execution of the terms of a machine-readable contract or agreement. Unlike a traditional contract which would be written in natural language, a smart contract is a machine-executable program that comprises rules that can process inputs to produce results, which can then cause actions to be performed dependent upon those results. In respect of commercial transactions, for example, these may involve the transfer of property rights and/or assets. Such assets may include real property, personal property (including both tangible and intangible property), digital assets, or any other type of asset. In the digital economy, there is often an expectation that exchanges and transfers will be performed in a timely manner and across vast distances. This expectation, along with practical and technical limitations, means that traditional forms of asset transfer, such as physical delivery of hard copies of documents representing a contract, negotiable instrument, etc., or the tangible asset itself, is not desirable. Thus, smart contracts can provide enhanced control, efficiency, and speed of transfer in the digital economy.

One type of digital asset that can be transferred via a blockchain is a “token.” Tokens represent and transfer assets via the blockchain. A token serves as an identifier that allows the real-world or digital asset to be referenced from the blockchain. Similar to physical assets, the tokens that represent them may have many properties, one of which is fungibility or non-fungibility. Fungibility refers to the equivalence or interchangeability of each unit of a commodity with other units of the same commodity. Fungible tokens (FTs) are tokens that can be exchanged for any other token with the same value.

Fungible tokens (FTs) are uniform, that is, FTs of the same type are identical in specification, and each FT is identical to another FT of the same type. FTs are divisible into smaller amounts. In other words, users can own or transfer a fraction of an FT. Non-fungible tokens (NFTs), however, cannot be replaced with other tokens of the same type. NFTs represent nonfungible assets. Nonfungible assets have unique information or attributes. Each NFT is unique and differs from other tokens of the same class. In contrast to FTs, NFTs cannot be divided as the elementary unit of the NFT is the token itself.

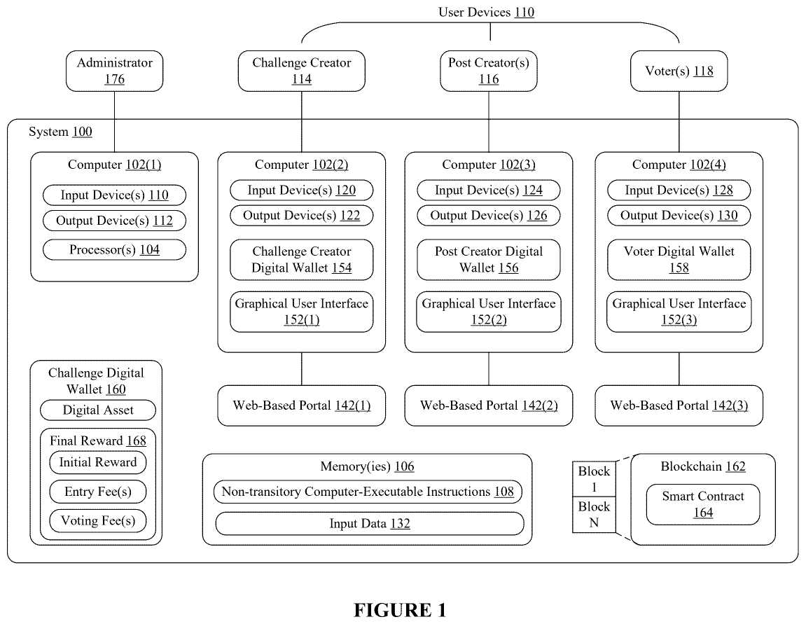

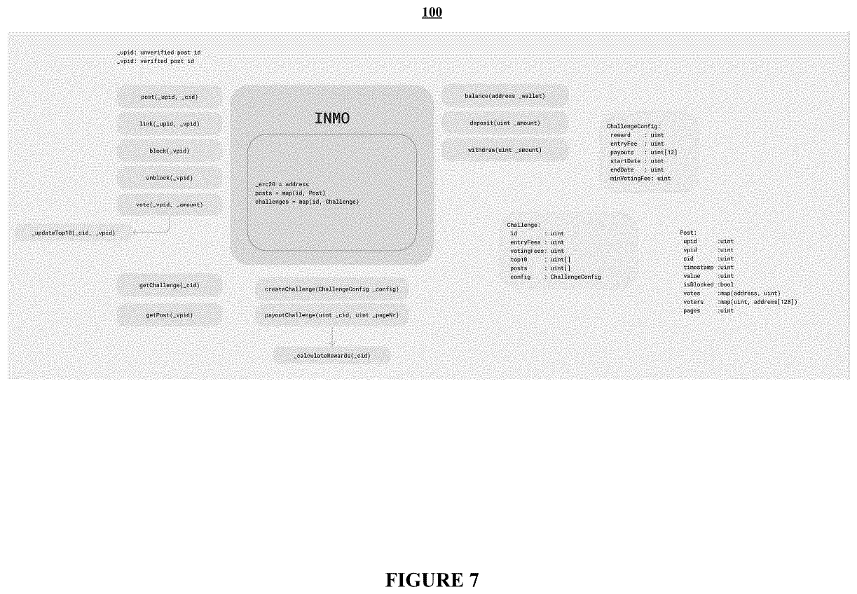

As shown in FIGS. 1-7, the systems disclosed herein include one or more processors. Further, the systems can include one or more memories. The memories can store non-transitory computer-executable instructions which, upon execution, can cause the first computer to perform operations or a computer-implemented method for incentivizing creative or original content on a digital platform via challenge functionality as briefly discussed above. The operations and computer-implemented methods performed by the at least one processor of the system are discussed in more detail below.

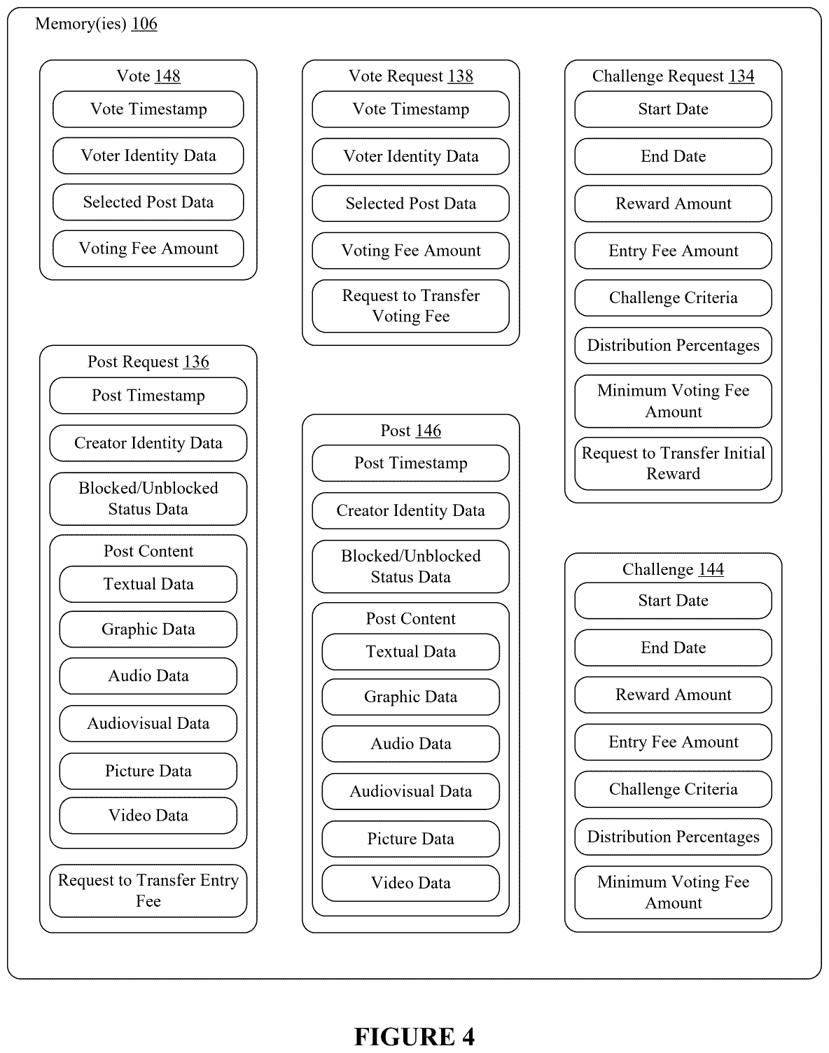

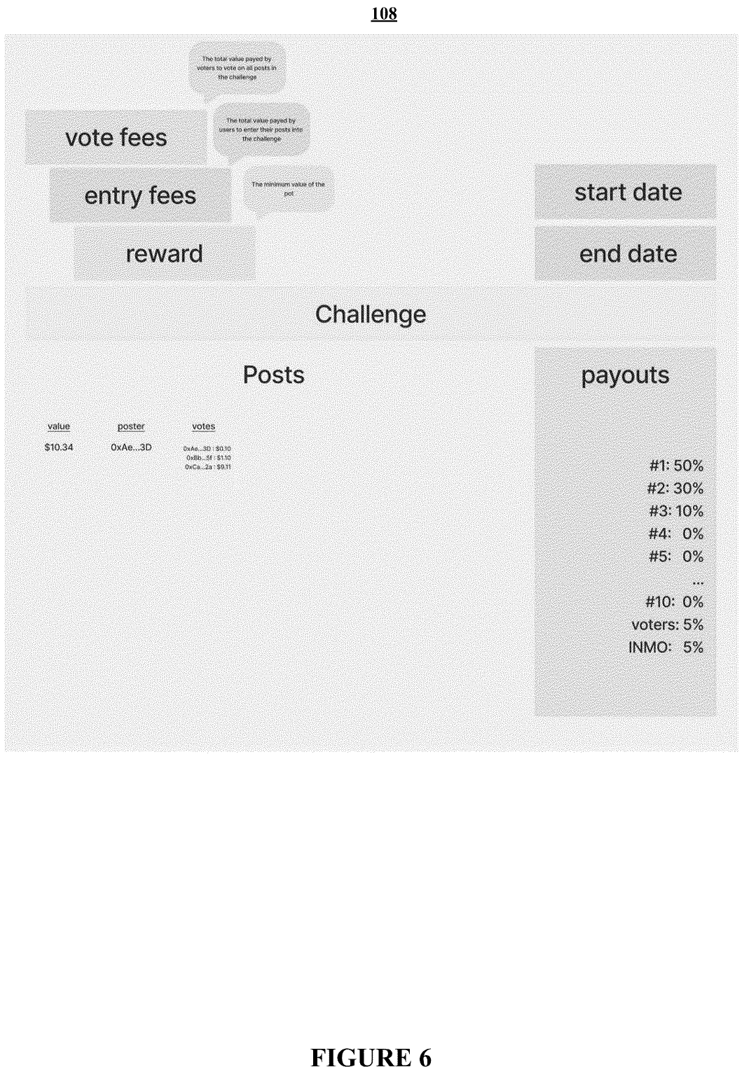

FIG. 1 is a schematic block diagram depicting one embodiment of a system 100 of the present disclosure. In embodiments, the system 100 comprises a social media platform. The system 100 can include one or more memories 106. FIG. 4 is a schematic block view depicting one embodiment of a memory 106 of the system 100 of the present disclosure. The memories 106 can store non-transitory computer-executable instructions 108. FIG. 6 is a visualization of one embodiment of the non-transitory computer-executable instructions 108 of the present disclosure. In one aspect, the system 100 disclosed herein includes a first computer 102(1), which can be a server. The first computer 102(1) can comprise at least one processor 104. The first computer 102(1) can also comprise one or more input devices 110 and one or more output devices 112. The non-transitory computer-executable instructions 108, upon execution, can cause the first computer 102(1) to generate and transfer digital assets or perform one or more of the operations or methods described herein.

In one aspect, the system 100 disclosed herein includes a second computer 102(2), which can be a user computer associated with a challenge creator 114. The second computer 102(2) can comprise one or more processors and one or more memories. The second computer 102(2) can also comprise one or more input devices 120 and one or more output devices 122. In another aspect, the system 100 disclosed herein includes a third computer 102(3), which can be a user computer associated with a post creator 116. The third computer 102(3) can comprise one or more processors and one or more memories. The third computer 102(3) can also comprise one or more input devices 124 and one or more output devices 126, such as one or more audio output devices, video output devices, or a combination thereof. In another aspect, the system 100 disclosed herein includes a fourth computer 102(4), which can be a user computer associated with a voter 118. The fourth computer 102(4) can comprise one or more processors and one or more memories. The fourth computer 102(4) can also comprise one or more input devices 128 and one or more output devices 130, such as one or more audio output devices, video output devices, or a combination thereof.

In one embodiment, the system 100 may include one or more user devices 110 (e.g., second computer 102(2), third computer 102(3), fourth computer 102(4)). The user devices 110 may include one or more challenge creator devices (e.g., second computer 102(2)), post creator devices (e.g., third computer 102(3)), and voter devices (e.g., fourth computer 102(4)). Although only three user devices 110 are depicted in FIG. 1, the system 100 may include any number of user devices 110. Each user computer can comprise one or more input devices (such as a mouse or a keyboard), one or more output devices (including visual output devices (i.e., a screen), and one or more audio output devices (i.e., speakers, headphones, etc.)), or a combination thereof. In some embodiments, the one or more user devices 110 are not part of the system 100 but rather are separate from the systems and communicate with the system 100 via a data network, such as the internet.

The system 100 can comprise data or data assets, such as input data 132, stored on the one or more memories 106 of the system 100. The data can include any content that is created or uploaded to the system 100 by a user (e.g., input data 132). As used herein, the term “input data” can refer to such data created by a challenge creator 114, post creator 116, or voter 118. In embodiments, the post creator 116 uploads (via a computer, e.g., post creator device 102(3)) the input data 132 for viewing voters 118. The voters 118 can view the input data 132 on a computer (e.g., voter device 102(4)). The input data 132 can include any one or more of the following: audio data, visual data, audiovisual data, or any other forms of data that can be viewed, heard, or otherwise accessed by a user. In embodiments, the audio data comprises an audio file that contains non-transitory computer-executable instructions that, when executed by a computer, cause the computer to play audio through an audio output device, such as a speakers or headphones. Audio files may contain (optionally only contain) non-transitory computer-executable instructions for playing audio from part of a complete song or track. For example, an audio file may only contain audio from a single instrument. An audio stem may also contain audio data from one portion of a track. The visual data can include still visual images or videos. The visual data can comprise video or image files containing non-transitory computer-executable instructions that encode for various visual images, components of images, videos, or components of videos that were created by the post creator 116. Audiovisual data can include data that is a combination of visual data and audio data, which is synchronized to provide a single, cohesive viewing experience by a voter 118. In some embodiments, the non-transitory computer-executable instructions 108 can be configured to, when executed by the first computer 102(1), cause the first computer 102(1) to generate a visual image or video using visual data. In some embodiments, the first computer 102(1) may generate a plurality of visual images or videos using the visual data. The non-transitory computer-executable instructions 108 can be configured to, when executed by the first computer 102(1), cause the first computer 102(1) to convert certain input data 132 (such as audio data, visual data, or audiovisual data created by a post creator 116) into data stored on a social media platform.

The non-transitory computer-executable instructions 108, when executed by the processor 104, may cause the processor 104 to perform the operation of providing a web-based portal 142 accessible via a computer application on a user device 110. The web-based portal 142 can be configured to display a graphical user interface 152 on the user computers 110. A web-based portal 142(1) may be accessible via the internet using a computer application on the user device 102(2) and display graphical user interface 152(1). A web-based portal 142(2) may be accessible via the internet using a computer application on the user device 102(3) and display graphical user interface 152(2). A web-based portal 142(3) may be accessible via the internet using a computer application on the user device 102(4) and display graphical user interface 152(3).

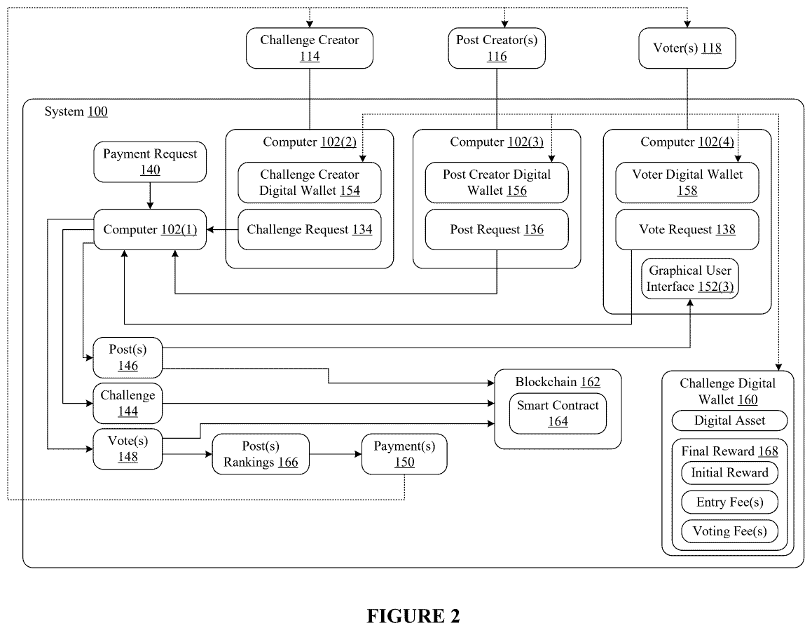

FIG. 2 is a schematic block view depicting one embodiment of the system 100 of the present disclosure. In the example of FIG. 2, the at least one processor 104 may perform the operation of receiving a challenge request 134 from a challenge creator 114. In some embodiments, the challenge creator 114 may be an owner or administrator of the system 100. The challenge creator 114 may also be a third-party content creator. The operation of receiving a challenge request 134 from a challenge creator 114 may include receiving a challenge request 134 from a digital wallet 154 of a challenge creator 114. The challenge request 134 may include one or more of a start date, an end date, an initial reward amount, an entry fee amount, a minimum voting fee amount, challenge criteria, or distribution percentages. Once received, the challenge request 134 may be stored in the at least one memory 106, as illustrated in FIG. 4.

In some embodiments, the challenge request 134 may include an initial reward amount or “initial pot.” The initial reward amount is the amount that the challenge creator 114 contributes toward the final reward amount 168, which may also be referred to simply as the “reward amount.” The initial reward amount may be any type of digital asset, including but not limited to an NFT(s), an FT(s), or a cryptocurrency(ies). For example, the initial reward may be a quantity of USD Coin (USDC), a stablecoin tied to the United States Dollar. The initial reward amount may be selected by the challenge creator 114 or may be a preset value for the system 100 such that all challenges have the same initial reward amount. In some embodiments, the system 100 may include a minimum initial reward amount. In such embodiments, the challenge creator 114 can select an initial reward amount equal to or greater than the minimum initial reward amount. The challenge request 134 may also include a request to transfer an initial reward equal to the initial reward amount from a digital wallet 154 of the challenge creator 114 to a challenge digital wallet 160.

The challenge request 134 may include an entry fee amount. The entry fee amount is the amount that post creators 116 must contribute to the reward amount in order to submit a post request 136 to enter the challenge. Like the initial reward amount, the entry fee amount may be any type of digital asset, including but not limited to an NFT(s), an FT(s), or a cryptocurrency (ies). For example, the entry fee amount may be a quantity of USDC. The entry fee amount may be selected by the challenge creator 114 or may be a preset value of the system 100 such that all challenges have the same entry fee amount.

The challenge request 134 may include a minimum voting fee amount. The minimum voting fee amount is the amount that voters 118 must contribute to the reward amount in order to submit a vote request 138 for one or more of the posts 146. Like the entry fee amount, the minimum voting fee amount may be any type of digital asset, including but not limited to an NFT(s), an FT(s), or a cryptocurrency (ies). For example, the minimum voting fee amount may be a quantity of USDC. The minimum voting fee amount may be selected by the challenge creator 114 or may be a preset value of the system 100 such that all challenges have the same minimum voting fee amount. As discussed below, in some embodiments, the value of a vote 148 may be weighted based on the voting fees submitted with such vote. In such embodiments, the minimum voting fee amount is only a minimum amount to allow voters 118 to submit additional voting fees to increase the weight given to their votes.

The challenge request 134 may include challenge criteria. The challenge criteria relate to the content of the post. In some embodiments, the challenge criteria can require that the post include textual, graphic, audio, visual, audiovisual, pictorial, or videographic content. The challenge criteria may also request that the post include content relating to a specific subject, activity, topic, issue, genre, field, category, type, or kind. Challenge criteria could also be as simple as asking post creators 116 to post an image or video that they find funny or entertaining. Challenge criteria may also be more complex or detailed. As a non-limiting example, the ALS Ice Bucket Challenge was a challenge that went viral on social media in 2014. The challenge criteria of the ALS Ice Bucket Challenge required that participants film themselves having a bucket of ice water poured on their heads, which was then posted on social media. Continuing the example, challenge criteria of the present invention could require post creators 116 to post a funny video of them performing the ALS Ice Bucket Challenge. The challenge criteria may include challenge content. The challenge content may include textual, graphic, audio, visual, audiovisual, pictorial, or videographic data such as a video of the challenge creator 114 explaining the challenge.

The challenge request 134 may also include distribution percentages that dictate how the final reward amount is distributed at the end of the challenge. Distribution percentage may be for one or more of the challenge creator 114, at least one of the plurality of post creators 116, and at least one of the plurality of voters 118. As a non-limiting example, the distribution percentages may include that the post creators 116 of the top three posts get 50%, 30%, and 10% of the final reward respectively; that the challenge creator 114 gets 5% of the final reward, and that the voters 118 for the top post split 5% of the reward. In some embodiments, the distribution percentages are at least for the challenge creator 114, the post creator from the plurality of post creators 116 associated with the highest ranked post, and the voters of the plurality of voters 118 that voted for the highest ranked post.

The non-transitory computer-executable instructions 108 may, when executed by the processor 104, cause the processor 104 to perform the operation of generating a challenge 144 in response to the challenge request 134. The challenge 144 generated in response to the challenge request 134 may include the one or more of the reward amount, the entry fee amount, the minimum voting fee amount, the start date, the end date, the challenge criteria, or the distribution percentages included in the challenge request 134. In certain embodiments, the first computer 102(1) can store certain data on a blockchain 162. The operation of generating the challenge request 134 may include generating a smart contract 164 on the blockchain 162. Among other things, the smart contract 164 may automate the execution of the terms of the challenge 144, such as the distribution of the final reward amount. In some embodiments, the generated challenge 144 is stored in the at least one memory 106, as illustrated in FIG. 4.

Generating the challenge request 134 may also include generating a challenge digital wallet 160 and facilitating or initiating the transfer of an initial reward equal to the initial reward amount from the challenge creator digital wallet 154 to the challenge digital wallet 160. The challenge digital wallet 160 may be a digital wallet associated with the generated challenge 144 and not any particular owner. The challenge digital wallet 160 may store the final reward, which includes the initial reward, until it is distributed.

The non-transitory computer-executable instructions 108, when executed by the processor 104, may cause the processor 104 to perform the operation of displaying the challenge 144 via a web-based portal 142. For example, the challenge 144 may be displayed on the graphical user interfaces 152 of one or more of the user devices 110. For example, the visual images or videos can be displayed via the graphical user interface and the audio data can be transmitted to a user via the audio output device of the user computers. Displaying the generated challenge 144 may include displaying one or more of the reward amount, the entry fee amount, the minimum voting fee amount, the start date, the end date, the challenge criteria, or the distribution percentages.

The non-transitory computer-executable instructions 108 may, when executed by the processor 104, cause the processor 104 to perform the operation of receiving post requests 136 from a plurality of post creators 116 in response to the challenge 144. The post requests 136 may be received from post creator digital wallets 156 associated with the plurality of post creators 116. Each post request 136 may include a request to transfer an entry fee equal to the entry fee amount from a post creator digital wallet 156 to the challenge digital wallet 160.

Each post request 136 may also include one or more of a post timestamp, creator identity data, blocked/unblocked status data, or post content. The post timestamp of each post request 136 may indicate the time that each post request 136 was issued or received. The post creator identity data identifies the post creator 116 so that the system 100 and administrators, challenge creators 114, and users of the system 100 can determine the creator of the post. For example, the post creator identity may be a name or username of the creator. In some embodiments, the post creator identity may be the address of a post creator digital wallet 156 (e.g., an IP address or a MAC address). Post content can include textual, graphic, audio, visual, audiovisual, pictorial, or videographic data. The post content may be in response to or related to the challenge criteria. Once received, the post request 136 may be stored in the at least one memory 106, as illustrated in FIG. 4.

The non-transitory computer-executable instructions 108 may, when executed by the processor 104, cause the processor 104 to perform the operation of generating posts 146 in response to the post requests 136. Each generated post 146 may be associated with the one of the plurality of post creators 116 that submitted the corresponding post request 136. Each post 146 generated in response to each post request 136 includes the corresponding one or more of the timestamp, the blocked/unblocked status data, the post creator identity data, or the post content. The operation of generating posts 146 may include facilitating the transfer of the entry fee from the post creator digital wallet 156 to the challenge digital wallet 160 in response to the request to transfer an entry fee equal to the entry fee amount from a post creator digital wallet 156 to the challenge digital wallet 160. The operation of generating posts 146 may include generating a block on the same blockchain 162 as the smart contract 164 for each of the posts 146. In some embodiments, the generated posts 146 are stored in the at least one memory 106, as illustrated in FIG. 4.

In some embodiments, at least one of the post requests 136 may be associated with a verified post creator digital wallet 156. In such embodiments, the operation of generating posts 146 in response to the post request 136 includes generating a post 146 in response to the post request 136 that is associated with a verified post creator digital wallet 156. In other embodiments, at least one of the post requests 136 may be associated with an unverified post creator digital wallet 156. In such embodiments, the non-transitory computer-executable instructions 108 may, when executed by the processor 104, cause the processor 104 to perform the operation of validating the unverified post creator digital wallet 156. The operation of generating posts 146 in response to the post request 136 may also include generating a post 146 in response to the post request 136 associated with the unverified post creator digital wallet 156 after validation of the unverified post creator digital wallet 156.

The non-transitory computer-executable instructions 108 may, when executed by the processor 104, cause the processor 104 to perform the operation of displaying the posts 146 via the web-based portal 142. The posts 146 may be displayed on the graphical user interface 152 of one or more of the user devices 110. Displaying the generated posts 146 may include displaying one or more of the timestamp, creator identity data, blocked/unblocked status data, or post content. In some embodiments, the creator identity data may be kept private to ensure that voters 118 vote for the best post rather than voting for a particular post creator 116. In some embodiments, the challenge 144 may be displayed before or with the posts 146. Users may also be able to scroll, swipe, or otherwise move through the posts 146.

The non-transitory computer-executable instructions 108 may, when executed by the processor 104, cause the processor 104 to receive vote requests 138 from a plurality of voters 118. Voters 118 may be users who view the challenge 144 and/or posts 146 of the graphical user interface 152(3) of a user device 102(4). Voters 118 may also include the challenge creator 114 or post creators 116. The graphical user interface 152(3) of the user device 110(4) may have a button or other user interface element that allows voters 118 to submit the vote request 138. Each vote request 138 may include at least one of the posts 146. The vote requests 138 may be received from voter digital wallets 158 associated with the plurality of voters 118. Each vote request 138 may include a request to transfer a voting fee equal to the voting fee amount from the voter digital wallet 158 to the challenge digital wallet 160.

Each vote request 138 may also include one or more of a vote timestamp, voter identity data, selected post data, or a voting fee amount. The vote timestamp of each vote request 138 may indicate the time that the vote request 138 was issued or received. The voter identity data identifies the voter 118 so that the system 100 and administrators, challenge creators 114, and/or users of the system 100 can determine the voter identity. The voter identity data may include a name or username of the voter 118. In some embodiments, the voter identity data may include the address of a voter digital wallet 158 (e.g., an IP address or a MAC address). The selected post data may be data about the post 146 that the voter 118 has selected to vote for, such as a post identifier. The voting fee amount may be an amount that the voter 118 would like to contribute to the reward amount along with the vote request 138. In embodiments including a minimum voting fee amount, the voting fee amount must be equal to or greater than the minimum voting fee amount to submit a vote request 138 for one or more of the posts 146. Once received, the vote request 138 may be stored in the at least one memory 106, as illustrated in FIG. 4.

The non-transitory computer-executable instructions 108 may, when executed by the processor 104, cause the processor 104 to perform the operation of generating votes 148 in response to the vote requests 138. Each generated vote 148 may be associated with the one of the plurality of voters 118 that submitted the corresponding vote request 138. Each vote 148 generated in response to each post request 136 includes the corresponding vote timestamp, voter identity data, selected post data, and/or the voting fee amount. The operation of generating votes 148 may include facilitating the transfer of the voting fee amount from the voter digital wallet 158 to the challenge digital wallet 160 in response to the request to transfer the voting fee equal to the voting fee amount from the voter digital wallet 158 to the challenge digital wallet 160. The operation of generating votes 148 may include generating a block on the same blockchain 162 as the smart contract 164 for each of the votes 148. In some embodiments, the generated votes 148 are stored in the at least one memory 106, as illustrated in FIG. 4.

The non-transitory computer-executable instructions 108 may, when executed by the processor 104, cause the processor 104 to perform the operation of ranking the posts 146 based on the votes 148 for each post. In some embodiments, the operation of ranking the posts 146 based on the votes 148 for each post includes ranking the posts 146 based on the number of separate votes each post receives. In other embodiments, the operation of ranking the posts 146 based on the votes 148 for each post includes ranking the posts 146 based on the sum of the voting fees transferred with each of the votes for each post. In other words, the votes 148 are weighted based on the voting fees submitted with each post. For example, a post receiving two votes transferred with 5 USDC for a total of 10 USDC would be ranked higher than a post receiving three votes each transferred with 3 USDC for a total of 9 USDC.

If the ranking 166 of the posts 146 results in a tie, a number of methods can be used to break the tic. For example, in either of the ranking methods discussed in the previous paragraph, a tie can be broken by ranking the later-generated post higher than the earlier-generated post. This may be done to reward the post creator 116 of the later generated post for receiving an equal amount of votes or an equally-weighted amount of votes in less time. In embodiments in which the votes 148 are weighted based on the fees transferred with the votes 148, a tie may also be broken by ranking the post that received more separate votes higher.

The non-transitory computer-executable instructions 108 may, when executed by the processor 104, cause the processor 104 to perform the operation of initiating payments 150 to one or more of the challenge creator 114, at least one of the plurality of post creators 116, and at least one of the plurality of voters 118. In some embodiments, the operation of initiating payments 150 may be performed automatically upon the end time of the challenge 144. The operation of initiating payments may occur in response to receiving a payment request 140 from a user such as a challenge creator 114, a post creator 116, or a voter 118. The operation of initiating payments 150 may include initiating the payments 150 to a challenge creator 114, a post creator 116, or a voter 118. The non-transitory computer-executable instructions 108 may include initiating payment 150 based on the distribution percentages and the final reward amount.

In some embodiments, the challenge request 134 may include a start time and an end time. The start time is the time after which the at least one processor 104 may perform the operations of receiving post requests 136 and vote requests 138 and generating posts 146 and votes 148. The end time may be the time after which the processor 104 may cease to perform the operation of receiving post requests 136 and vote requests 138 and generating posts 146 and votes 148 and may perform the operations of receiving payment requests 140 and initiating payments 150. The start time and end time may include both a date and time (e.g., Jan. 1, 2024 at 12:00 AM).

In some embodiments, the operation of initiating payments 150 to one or more of the challenge creator 114, at least one of the plurality of post creators 116, and at least one of the plurality of voters 118 in response to the payment request 140 includes initiating the transfer of digital assets from a challenge digital wallet 160 to the digital wallets of one or more of the challenge creator 114, at least one of the plurality of post creators 116, and at least one of the plurality of voters 118. The payments 150 may credit the accounts of voters 118, post creators 116, and/or challenge creators 114. In such embodiments, the owners of the digital wallets withdraw the funds from the smart contract 164 to ensure that only the challenge creator 114, post creator 116, or voter 118 has access to their corresponding funds. The system 100 owner, administrator, and/or challenge creator 114 do not have access to the final reward amount.

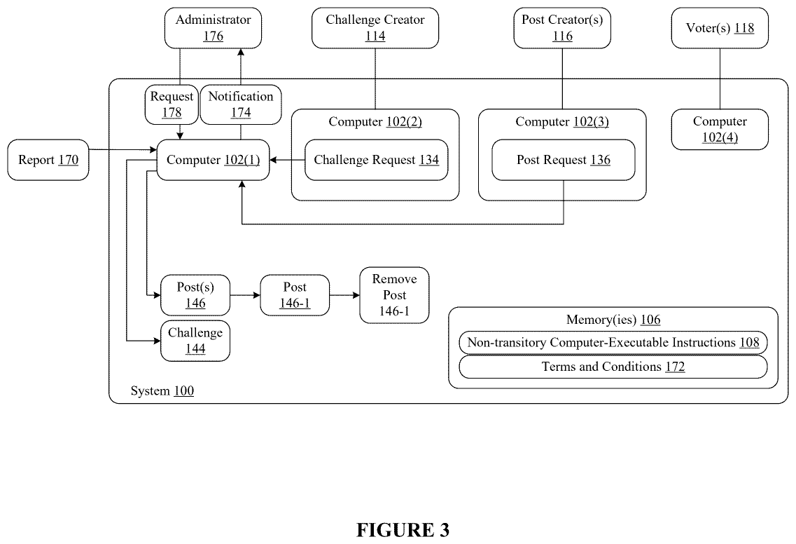

As illustrated in FIG. 3, in some embodiments, the non-transitory computer-executable instructions 108 may, when executed by the processor 104, cause the processor 104 to perform the operation of receiving, from a user, a report 170 stating that a post 146-1 violates the terms and conditions 172 of the system 100. For example, the report 170 may state that a post 146-1 contains inappropriate statements or images. The processor 104 may also perform the operation of sending a notification 174 to an administrator 176 regarding the report 170. For example, the notification 174 may include the post 146-1 and a statement about the reason it was reported. The processor 104 may also perform the operation of receiving, from the administrator 176, a request 178 to allow the post 146-1 to be displayed and voted on or to block the post 146-1 from being displayed or from being included in a vote request 138 or a vote 148. If a request to block the post 146-1 from being displayed is received, the processor 104 may perform the operation of removing the post 146-1 from being displayed.

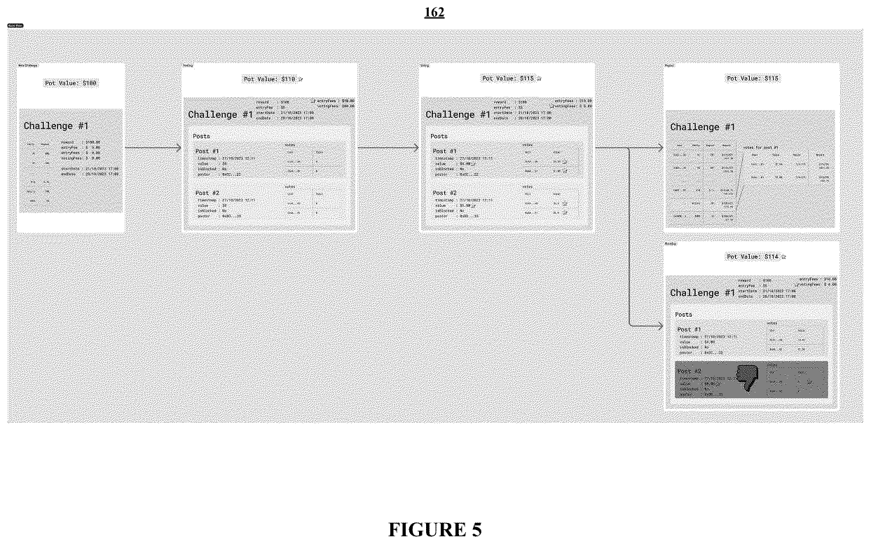

FIG. 5 is a visualization of one embodiment of the blockchain 162 of the present disclosure. In certain embodiments, the first computing device 102(1) can store certain data on the blockchain 162. For example, certain data can be converted or “minted” into an NFT by publishing a unique instance of the data to a blockchain. Once the data (e.g., input data 132, challenge, 144, posts 146, votes 148, the initial reward amount, and/or final reward 168) are converted into one or more digital assets (e.g., an NFT) stored on the blockchain 162, they can become salable or transferable. The digital assets may also contain metadata, such as the digital asset identification number or information about the data. In some embodiments, the creation of digital assets stored on the blockchain 162 can be performed via a third-party NFT platform. In such embodiments, the first computer 102(1) can be communicably connected with the third-party platform, for example, via the internet. The non-transitory computer-executable instructions 108 of such an embodiment can be configured to, when executed by the first computer 102(1), cause the first computer 102(1) to transmit instructions to and receive data from the third-party platform. In other embodiments, the conversion of the data into one or more digital assets stored on the blockchain 162 can be done directly by the system 100 without the need for a third-party platform.

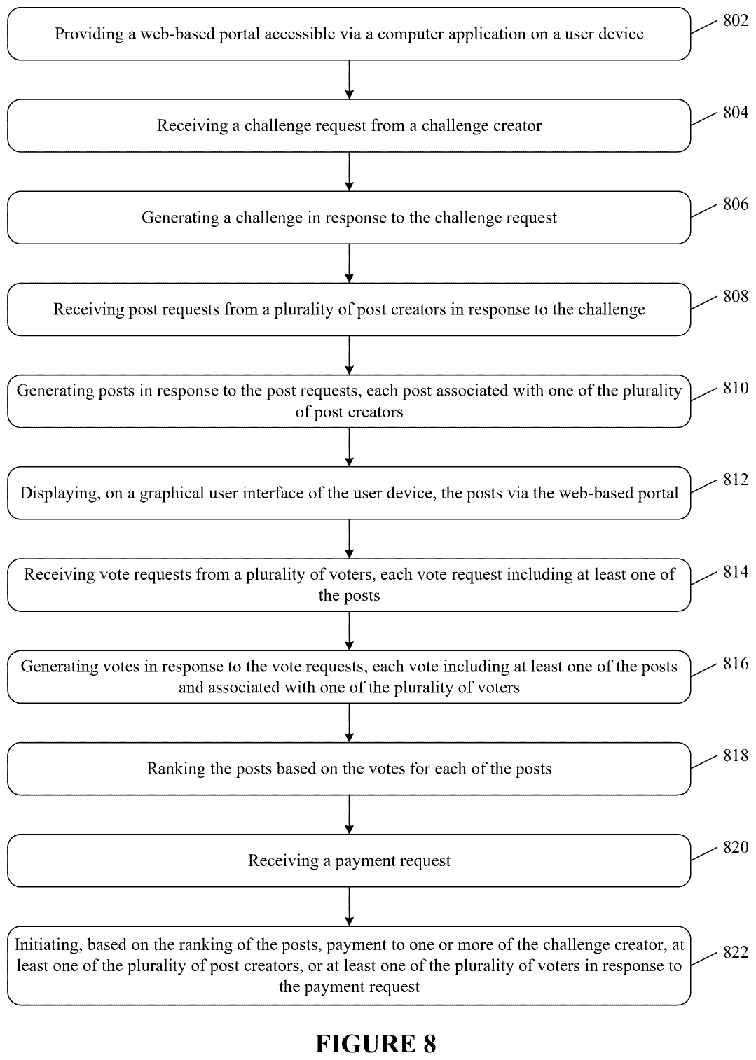

FIG. 8 depicts one embodiment of a method 800 of the present disclosure. The methods may be computer-implemented methods. The methods may include one or more steps. Some embodiments of the methods may include providing a system. The system may include the system 100 of FIG. 1 or other systems described herein. The system may include the server with the at least one processor and at least one memory. In some embodiments, the methods may include storing one or more non-transitory computer-executable instructions. The methods may include executing the non-transitory computer-executable instructions on the at least one processor.

In the embodiment shown in FIG. 8, the method may include the step 802 of providing a web-based portal. The web-based portal may be accessible via a computer application on a user device. The method may also include the steps of receiving a challenge request from a challenge creator (804); generating a challenge in response to the challenge request (806); receiving post requests from a plurality of post creators in response to the challenge (808); generating posts in response to the post requests, each post associated with one of the plurality of post creators (810); displaying, on a graphical user interface of the user device, the posts via the web-based portal (812); receiving vote requests from a plurality of voters, each vote request including at least one of the posts (814); generating votes in response to the vote requests, each vote including at least one of the posts and associated with one of the plurality of voters (816); ranking the posts based on the votes for each of the posts (818); receiving a payment request (820); and initiating, based on the ranking of the posts, payment to one or more of the challenge creator, at least one of the plurality of post creators, or at least one of the plurality of voters in response to the payment request (822). The steps of the method 800 are discussed in greater detail below.

The method may include the step 804 of receiving a challenge request from a challenge creator. The challenge request may include a start time, an end time, an initial reward amount, an entry fee amount, a minimum voting fee amount, challenge criteria, and/or distribution percentages as discussed elsewhere herein. The step 804 of receiving a challenge request from a challenge creator may include the step of receiving a challenge request from a challenge creator digital wallet.

The method may include the step 806 of generating a challenge. The step 806 of generating a challenge may be performed in response to the step 804 of receiving the challenge request. The challenge generated in response to the challenge request includes the one or more of the reward amount, the entry fee amount, the minimum voting fee amount, the start date, the end date, the challenge criteria, or the distribution percentages of the challenge request. The step 806 of generating a challenge may include the step of generating a smart contract on a blockchain. The step 806 of generating a challenge may also include facilitating the transfer of an initial reward equal to the initial reward amount from a challenge creator digital wallet to a challenge digital wallet.

The method may include the step 808 of receiving post requests from a plurality of post creators in response to the challenge. The step 808 of receiving post requests may be performed after the start time and/or before the end time. Each of the post requests may include one or more of a timestamp, post creator identity data, blocked/unblocked status data, or post content, such as audio data, visual data, audiovisual data, or text data. The post requests may be associated with a verified or unverified post creator wallet. In some implementations, each post request may also include a request to transfer an entry fee equal to the entry fee amount from a post creator digital wallet to a challenge digital wallet. In such implementations, the operation of receiving post requests from a plurality of post creators in response to the challenge includes receiving post requests from post creator digital wallets associated with the plurality of post creators.

The method may include the step 810 of generating posts. The step 810 of generating posts may be performed in response to the step 808 of receiving the post requests. Each post generated in response to each post request may include the corresponding one or more of the timestamp, post creator identity data, blocked/unblocked status data, or post content of each respective post request. Each post may be associated with one of the plurality of post creators. The step 810 of generating posts may be performed after the start time and/or before the end time. In some implementations, the step 810 of generating posts includes generating a block on the same blockchain as the smart contract for each of the posts.

In implementations where each post request includes a request to transfer an entry fee equal to the entry fee amount from a post creator digital wallet to a challenge digital wallet, the step 810 of generating posts includes facilitating the transfer of the entry fee from a post creator digital wallet to a challenge digital wallet for each post request. In implementations where at least one of the post requests is associated with a verified post creator digital wallet, the operation of generating posts in response to the post request may include generating a post in response to the post request that is associated with a verified post creator digital wallet. In implementations where at least one of the post requests is associated with an unverified post creator digital wallet, the method may include a step of validating the unverified post creator digital wallet. In such implementations, the operation of generating posts in response to the post requests includes generating posts in response to the at least one post request associated with an unverified post creator digital wallet after validation of the unverified post creator digital wallet.

The method may include the step 814 of receiving vote requests from a plurality of voters. Each vote request may include at least one of the posts. The step 814 of receiving vote requests may be performed after the start time and/or before the end time. Each of the vote requests may include one or more of voter identity data, selected post data, or a voting fee amount. In some implementations, each post request may also include a request to transfer a voting fee equal to or greater than the minimum voting fee amount from a voter digital wallet to a challenge digital wallet. In such implementations, the step 814 of receiving vote requests from a plurality of voters in response includes receiving vote requests from voter digital wallets associated with the plurality of voters.

The method may include the step 816 of generating votes. The step 816 of generating votes may be performed in response to the step 814 of receiving the vote requests. Each vote generated in response to each vote request may include the corresponding one or more of voter identity data, selected post data, or the voting fee amount of each respective vote request. Each vote may be associated with one of the plurality of voters and/or include at least one of the posts. The step 816 of generating votes may be performed after the start time and/or before the end time. In implementations where each vote request includes a request to transfer a voting fee equal to or greater than the entry fee amount from a voter digital wallet to a challenge digital wallet, the step 816 of generating votes includes facilitating the transfer of the voting fee from a voter digital wallet to a challenge digital wallet for each vote request. In some implementations, the step 816 of generating votes includes generating a block on the same blockchain as the smart contract for each of the votes.

The method may include the step 818 of ranking the posts based on the votes for each of the posts. In some embodiments, the step 818 of ranking the posts based on the votes for each post may be based on the total number of separate votes for each post. In other embodiments, the operation of ranking the posts based on the votes for each of the posts includes ranking the posts based on the amount of the voting fees transferred with each vote for each post as described elsewhere herein. In implementations where at least two of the posts are ranked equally, the step 818 of ranking the posts includes ranking the later-generated of the at least two posts higher than the earlier-generated of the at least two posts.

The method may also include the steps 820, 822 of receiving a payment request and initiating, based on the ranking of the posts, payment to one or more of the challenge creator, at least one of the plurality of post creators, or at least one of the plurality of voters in response to the payment request. The steps 820, 822 of receiving a payment request and initiating payments may be performed after the end time. In implementations where the challenge request includes distribution percentages for one or more of the challenge creator, at least one of the plurality of post creators, and at least one of the plurality of voters, the step 822 of initiating payment includes initiating payment to one or more of the challenge creator, at least one of the plurality of post creators, and at least one of the plurality of voters based on the distribution percentages. In some implementations, the step 822 of initiating payments to one or more of the challenge creator, at least one of the plurality of post creators, and at least one of the plurality of voters in response to the payment request includes initiating the transfer of a digital asset from a challenge digital wallet to the digital wallets of one or more of the challenge creator, at least one of the plurality of post creators, or at least one of the plurality of voters.

In some implementations, the method may include steps for blocking posts. In such implementations, the method may include the step of receiving, from a user, a report stating that a post violates the terms and conditions of the system. The method may also include the step of sending a notification request to an administrator regarding the report. The method may also include the step of receiving, from the administrator, a request to block a post from being displayed or from being included in a vote request or a vote, or to allow the post to be displayed or to be included in a vote request or a vote. When a request to block a post is received from the administrator, the method may include the step of removing the post from being displayed or from being included in a vote request or a vote.

Some of the steps of the above-described methods have been described above. In some embodiments, other elements of the system 100 may perform one or more of those steps, not just those described in relation to the methods. For example, in some embodiments, one or more processors may perform one or more of the steps of the method. In one or more embodiments, a step of a method may include sub-steps or functionality described above in relation to FIG. 8, although not explicitly described in relation to FIG. 8.

The presently disclosed systems and methods have a wide application anywhere in the computer industry where the incentivization of creative or original content is needed. One particularly important application for the systems and methods described herein relates to the incentivization of creative or original content on digital platforms such as social media platforms. However, the systems and methods described above could be utilized in other contexts.

### Examples

Over 50 million people consider themselves creators. The freedom of expression along with the desire to leave the traditional 9-5 behind have resulted in today's creator economy. People are seeking to turn their passions into professions.

However, even with all the effort and time put into content creation, the prospect of a reward as an “influencer” is diminishing. Here are a few non-limiting reasons why:

Competition—gone are the days when posting high-quality photos was enough. The market is so saturated, and original content is not always rewarded.

Burnout—the pressure to produce content can be overwhelming, and with no real prompt or guides, it can cause influencers to regurgitate content rather than create something original, especially when original content does not earn the growth and engagement they are hoping for.

Algorithms—the current social media platforms have ever-changing algorithms, making it increasingly difficult for creators to get their content seen.

Inconsistencies in how to earn an income—not only is influencers' income regularly tied to brand deals and sponsorships, but also the social media platforms themselves are regularly pausing or changing the bonus structure they offer, making it difficult to earn an income.

The systems and methods disclosed herein operate differently than prior social media platforms. The presently disclosed systems and methods value authenticity and original content above all else, and are configured to heighten the reward for creators. In embodiments, the systems and methods disclosed herein include a fully monetized social media app. In the exemplary app, it pays to be original. Unlike traditional social media platforms, the presently disclosed platform rewards creators for the creator's content (or input data) directly, building a sustainable ecosystem for content creators. In various embodiments, the presently disclosed platform provides creators with the tools they need to thrive.

Embodiments of the present disclosure comprise a fully monetized digital platform for all creators to showcase their original content and get paid. Certain embodiments are available across a plurality of operating platforms for use on any mobile device or computer. Embodiments are available for IOS and Android platforms.

The presently disclosed digital platform includes a content creation app, wherein content creators keep all the money earned through engagements and interactions on the app.

In various embodiments, the presently disclosed platform is configured to inspire endless creativity and collaboration with other users and content creators.

Certain embodiments permit content creators to challenge other creators to healthy competition and go head-to-head to earn NFTs.

In one embodiment, the presently disclosed systems and methods include a completely monetized platform using its own version of data assets (such as an NFT) as the currency. In embodiments, spending and earning such data assets allows for content, creativity, and payouts to flow between content creators.

A method of monetizing short-form content is also disclosed herein. In embodiments, the amount the creator earns is directly proportional to third-party user engagement with any content that the creator uploads to a social media platform.

### EQUIVALENTS

Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

What is claimed is:

1. A system for incentivizing creative or original content on a digital platform via challenge functionality, the system comprising:
at least one processor;
at least one memory storing non-transitory computer-executable instructions;
wherein, when executed by the processor, the non-transitory computer-executable instructions cause the processor to perform operations comprising:
providing a web-based portal accessible via a computer application on a user device;
receiving a challenge request from a challenge creator;
generating a challenge in response to the challenge request;
receiving post requests from a plurality of post creators in response to the challenge;
generating posts in response to the post requests, each post associated with one of the plurality of post creators;
displaying, on a graphical user interface of the user device, the posts via the web-based portal;
receiving vote requests from a plurality of voters, each vote request including at least one of the posts;
generating votes in response to the vote requests, each vote including at least one of the posts and associated with one of the plurality of voters;
ranking the posts based on the votes for each of the posts;
receiving a payment request; and
initiating, based on the ranking of the posts, payment to one or more of the challenge creator, at least one of the plurality of post creators, or at least one of the plurality of voters in response to the payment request.

2. The system of claim 1, wherein the challenge request includes a start time and an end time, wherein the operations of receiving the post requests and generating the posts are performed after the start time and before the end time; and wherein the operations of receiving the payment request and initiating the payment is performed after the end time.

3. The system of claim 1, wherein the challenge request includes an initial reward amount; and wherein generating the challenge includes generating a smart contract and facilitating a transfer of an initial reward equal to the initial reward amount from a challenge creator digital wallet to a challenge digital wallet.

4. The system of claim 1, wherein the challenge request includes an entry fee amount; wherein each post request includes a request to transfer an entry fee equal to the entry fee amount from a post creator digital wallet to a challenge digital wallet; and wherein the operation of generating the posts includes facilitating transfer of the entry fee from the post creator digital wallet to the challenge digital wallet for each post request.

5. The system of claim 1, wherein the challenge request includes a minimum voting fee amount; wherein each vote request includes a request to transfer a voting fee equal to or greater than the minimum voting fee amount from a voter digital wallet to a challenge digital wallet; and wherein generating votes includes facilitating transfers of the voting fee from the voter digital wallet to the challenge digital wallet for each vote request.

6. The system of claim 5, wherein the operation of ranking the posts based on the votes for each of the posts includes ranking the posts based on an amount of voting fees transferred with each vote.

7. The system of claim 1, wherein at least two of the posts are equally ranked when ranked based on the votes for each of the posts; and wherein the operation of ranking the posts includes ranking a later-generated of the at least two posts that are equally ranked higher an earlier-generated of the at least two posts that are equally ranked.

8. The system of claim 1, wherein the challenge request includes distribution percentages for one or more of the challenge creator, at least one of the plurality of post creators, and at least one of the plurality of voters; and wherein the operation of initiating the payment includes initiating payment to one or more of the challenge creator, at least one of the plurality of post creators, and at least one of the plurality of voters based on the distribution percentages.

9. The system of claim 8, wherein the distribution percentages are at least for the challenge creator, a post creator from the plurality of post creators associated with a post that is highest ranked, and the voters of the plurality of voters that voted for the post that is the highest ranked.

10. The system of claim 1, wherein the operation of initiating the payment to the one or more of the challenge creator, at least one of the plurality of post creators, and at least one of the plurality of voters includes initiating a transfer of a digital asset from a challenge digital wallet to digital wallets of one or more of the challenge creator, at least one of the plurality of post creators, and at least one of the plurality of voters.

11. The system of claim 1, wherein the operation of receiving the challenge request from the challenge creator includes receiving the challenge request from a challenge creator digital wallet.

12. The system of claim 1, wherein the operation of generating the challenge includes generating a smart contract on a blockchain, wherein the operation of generating the posts includes generating, for each of the posts, a block on the blockchain with the smart contract, and wherein the operation of generating the votes includes generating, for each of the votes, a block on the blockchain with the smart contract.

13. The system of claim 1, wherein the operation of receiving the post requests from the plurality of post creators in response to the challenge includes receiving the post requests from post creator digital wallets associated with the plurality of post creators, wherein at least one of the post requests is associated with a verified post creator digital wallet from among the post creator digital wallets; and wherein the operation of generating the posts in response to the post requests includes generating a post in response to the at least one post request that is associated with the verified post creator digital wallet.

14. The system of claim 1, wherein the operation of receiving the post requests from the plurality of post creators in response to the challenge includes receiving the post requests from post creator digital wallets associated with the plurality of post creators, wherein at least one of the post requests is associated with an unverified post creator digital wallet from among the post creator digital wallets; wherein the operations further comprise validating the unverified post creator digital wallet; and wherein the operation of generating the posts in response to the post requests includes generating a post in response to the at least one post request that is associated with the unverified post creator digital wallet after validating the unverified post creator digital wallet.

15. The system of claim 1, wherein the operations further comprise:
receiving, from a user, a report stating that a post violates terms and conditions of the system;
sending a notification to an administrator regarding the report;
receiving, from the administrator, a request to block the post from being displayed or from being included in a vote request or a vote; and
removing the post from being displayed or from being included in a vote request or a vote.

16. The system of claim 1, wherein the challenge request includes one or more of an initial reward amount, an entry fee amount, a minimum voting fee amount, a start time, an end time, challenge criteria, or distribution percentages; and wherein the challenge generated in response to the challenge request includes the one or more of the reward amount, the entry fee amount, the minimum voting fee amount, the start date, the end date, the challenge criteria, or the distribution percentages.

17. The system of claim 1, wherein each post request includes one or more of a timestamp, post creator identity data, blocked/unblocked status data, or post content; and wherein each post generated in response to each post request includes a corresponding one or more of the timestamp, the post creator identity data, the blocked/unblocked status data, or the post content.

18. The system of claim 1, wherein each vote request includes one or more of voter identity data, selected post data, or a voting fee amount; and wherein each vote generated in response to each vote request includes a corresponding one or more of the voter identity data, the selected post data, or the voting fee amount.

19. A system for incentivizing creative or original content on a digital platform via challenge functionality, the system comprising:
at least one memory storing non-transitory computer-executable instructions;
a first computing device with at least one processor;
a second computing device associated with a voter;
wherein, when executed by the second computing device, the non-transitory computer-executable instructions cause the second computing device to perform operations comprising:
accessing a web-based portal via a computer application on the second computing device, wherein posts are displayed on a graphical user interface of the second computing device via the web-based portal, each post associated with a post creator from among a plurality of post creators in response to a challenge;
sending, to the first computing device, at least one vote request including at least one of the posts, the at least one of the posts selected via a user interface element of the graphical user interface, wherein the at least one vote request is sent in response to the user interface element selection;
sending, to the first computing device, a payment request; and
receiving, based on a ranking of the posts based on votes for each of the posts, a payment in response to the payment request, wherein the votes include a vote generated from the vote request.

20. A method for incentivizing creative or original content on a digital platform via challenge functionality, the method comprising:
providing, by a computing device, a web-based portal accessible via a computer application on a user device;
receiving, by the computing device, a challenge request from a challenge creator;
generating, by the computing device, a challenge in response to the challenge request;
receiving, by the computing device, post requests from a plurality of post creators in response to the challenge;
generating, by the computing device, posts in response to the post requests, each post associated with one of the plurality of post creators;
displaying, by the computing device on a graphical user interface of the user device, the posts via the web-based portal;
receiving, by the computing device, vote requests from a plurality of voters, each vote request including at least one of the posts;
generating, by the computing device, votes in response to the vote requests, each vote including at least one of the posts and associated with one of the plurality of voters;
ranking, by the computing device, the posts based on the votes for each of the posts;
receiving, by the computing device, a payment request; and
initiating, by the computing device based on the ranking of the posts, payment to one or more of the challenge creator, at least one of the plurality of post creators, or at least one of the plurality of voters in response to the payment request.
